(19) United States
(12) Patent Application Publication
(10) Pub. No.: US 2026/0341247 A1
(43) Pub. Date: Oct. 29, 2026

(54) SCAN OUTPUT CIRCUIT AND DISPLAY DEVICE

(71) Applicant: ROHM Co., LTD., Kyoto (JP)

(72) Inventor: Kenichi Shiibayashi, Kyoto (JP)

(21) Appl. No.: 19/647,647

(22) Filed: Apr. 14, 2026

(30) Foreign Application Priority Data
Apr. 24, 2025 (JP) 2025-072314

(51) Int. Cl. G09G 3/36; G09G 3/34

(52) U.S. Cl. CPC G09G 3/3677; G09G 3/3426; G09G 3/3688; G09G 2310/027; G09G 2330/021; G09G 2330/045

(57) ABSTRACT

There is provided a scan output circuit which is connected to field-effect transistors each supplying a drain-source current to a backlight panel including a plurality of light-emitting diodes arranged in a matrix and which supplies a gate voltage to each of the field-effect transistors, including voltage output sections which are provided corresponding to the field-effect transistors and each of which outputs the gate voltage. Each of the voltage output sections is supplied with a positive power supply voltage through a first voltage supply line connected in common to a source of each of the field-effect transistors and is supplied with a negative voltage through a second voltage supply line, and according to the positive power supply voltage and the negative voltage, outputs a voltage which varies in voltage level between high and low levels and which has a negative voltage value at the low level, as the gate voltage.

The present disclosure contains subject matter related to that disclosed in Japanese Priority Patent Application JP 2025-072314 filed in the Japan Patent Office on Apr. 24, 2025, the entire content of which is hereby incorporated by reference.

### SUMMARY

The present disclosure relates to a scan output circuit and particularly, to a scan output circuit which supplies a gate voltage to a field-effect transistor (FET) that supplies a drain-source voltage to a light-emitting diode (LED).

In recent years, liquid crystal display devices using LEDs as backlight sources have been used. As a driving method for the LEDs in a backlight panel, a method generally called matrix driving in which a plurality of LEDs are sequentially driven in a time-division manner by using FETs as switches has been used.

In order to suppress occurrence of a leakage current when the LEDs are driven, there is proposed an LED driver including a first transistor which generates an output current corresponding to a drive voltage and allows the output current to flow between its drain and source, a second transistor which leads the output current generated by the first transistor in an on state to a reference voltage line to which a reference voltage is applied, and a constituent element which is configured to control the second transistor to be in an on state when an instruction signal indicates driving of a load or to control the second transistor to be in an off state and apply a control voltage having a predetermined voltage value higher than the reference voltage to the source of the first transistor when the instruction signal indicates non-driving of the load (for example, Japanese Patent Laid-Open No. 2024-167971).

In matrix driving for LEDs, it is required to drive a large current of several tens of milliamps through FETs when the LEDs emit light. Increasing an LED power supply voltage VLED to a higher level and increasing a gate-to-source voltage Vgs of each FET allow the large current to flow. However, this method causes excessive heat generation and power consumption in a backlight panel.

According to an embodiment of the present disclosure, there is provided a scan output circuit which is connected to a plurality of field-effect transistors each supplying a drain-source current to a backlight panel including a plurality of light-emitting diodes arranged in a matrix and which supplies a gate voltage to each of the plurality of field-effect transistors. The scan output circuit includes a plurality of voltage output sections which are provided corresponding to the plurality of field-effect transistors and each of which outputs the gate voltage. Each of the plurality of voltage output sections is supplied with a positive power supply voltage through a first voltage supply line connected in common to a source of each of the plurality of field-effect transistors and is supplied with a negative voltage through a second voltage supply line, and according to the positive power supply voltage and the negative voltage, outputs a voltage which varies in voltage level between a high level and a low level and which has a negative voltage value at the low level, as the gate voltage.

### BRIEF DESCRIPTION OF THE DRAWINGS

FIG. 1 is a block diagram illustrating a configuration of a display device according to a first embodiment of the present disclosure;

FIG. 2 is a circuit diagram illustrating configurations of a source output circuit, a scan output circuit, and its peripheral circuit blocks according to the first embodiment;

FIG. 3 is a timing chart indicating temporal changes of signals in matrix driving of LEDs;

FIG. 4A is a diagram illustrating a gate-to-source voltage of a control transistor according to a comparative example;

FIG. 4B is a diagram illustrating a gate-to-source voltage of a control transistor according to the first embodiment;

FIG. 5 is a graph indicating I-V characteristics of FETs constituting the control transistors; and

FIG. 6 is a circuit diagram illustrating configurations of a source output circuit, a scan integrated circuit (IC), and its peripheral circuit blocks according to a second embodiment.

### DETAILED DESCRIPTION

Preferred embodiments of the present disclosure will be described in detail below. Note that, in the following description and the attached drawings according to each of the embodiments, components having substantially the same or equivalent function are denoted by the same reference signs.

### First Embodiment

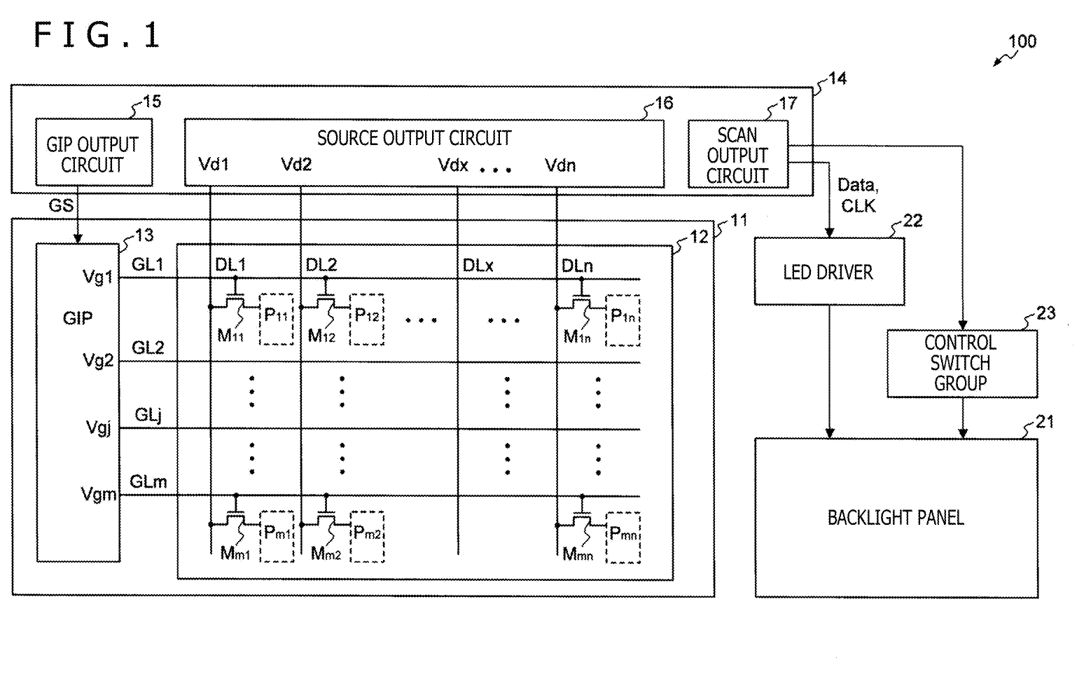

FIG. 1 is a block diagram illustrating a configuration of a liquid crystal display device 100 according to a first embodiment of the present disclosure. The liquid crystal display device 100 is an active matrix liquid crystal display device. The liquid crystal display device 100 includes a display panel 11, a T-CON (timing controller) embedded driver (TED) 14, a backlight panel 21, an LED driver 22, and a control switch group 23.

The display panel 11 is a liquid crystal display panel and is formed of a glass substrate including an image display region 12 and a gate in panel (GIP) 13 serving as a gate driver equipped using a GIP technique.

In the image display region 12 of the display panel 11, a plurality of pixel sections P11 to Pmn and a plurality of pixel switches M11 to Mmn (m and n are integers greater than or equal to 2) are arranged in an m-row × n-column matrix arrangement. In addition, in the image display region 12, m gate lines GL1 to GLm serving as horizontal scanning lines and n data lines DL1 to DLn which are arranged so as to cross the m gate lines GL1 to GLm are provided. The pixel sections P11 to Pmn and the pixel switches M11 to Mmn are each provided at each intersection of the gate lines GL1 to GLm and the data lines DL1 to DLn and are arranged in a matrix.

The pixel switches M11 to Mmn are controlled to be in an on or off state according to scanning gate signals Vg1 to Vgm which are supplied from the GIP 13. The pixel sections P11 to Pmn are supplied with gray-scale voltage signals Vd1 to Vdn corresponding to video image data from the source output circuit 16 provided in the TED 14. When each of the pixel switches M11 to Mmn is in an on state, the gray-scale voltage signals Vd1 to Vdn are applied to respective pixel electrodes of the pixel sections P11 to Pmn. As a result, each of the pixel electrodes is charged. The luminance of each of the pixel sections P11 to Pmn is controlled according to the gray-scale voltage signals Vd1 to Vdn at each of the pixel electrodes of the pixel sections P11 to Pmn. Thus, image display is performed.

The GIP 13 sequentially applies the scanning gate signals Vg1 to Vgm including horizontal scanning pulses to the respective gate lines GL1 to GLm of the display panel 11. Owing to supply of the scanning gate signals Vg1 to Vgm, the pixel sections P11 to Pmn are selected for each pixel row. The gray-scale voltage signals Vd1 to Vdn are repetitively supplied from the source output circuit 16 by selectively switching one row of the pixel sections, thereby allowing one frame of image display to be performed.

The TED 14 includes a display driver IC having a function of a display controller (T-CON) and a source driver. The TED 14 has a GIP output circuit 15, a source output circuit 16, and a scan output circuit 17.

The GIP output circuit 15 supplies a gate control signal GS controlling a timing at which the GIP 13 applies a horizontal scanning pulse to each of the gate lines, to the GIP 13.

The source output circuit 16 is a circuit having a function of the source driver provided in the TED 14, receives a video data signal including a series of a plurality of pieces of pixel data, generates the gray-scale voltage signals Vd1 to Vdn corresponding to gray-scale voltages having multiple levels corresponding to the number of gradation levels indicated by the video data signal, and supplies the generated gray-scale voltage signals Vd1 to Vdn to the data lines DL1 to DLn.

The scan output circuit 17 is a circuit which controls an operation of the LED driver 22 (that is, driving of the LEDs of the backlight panel 21). The scan output circuit 17 supplies data Data and a clock signal CLK to the LED driver 22. Also, the scan output circuit 17 performs switching control of the control switch group 23 for performing matrix driving of the LEDs.

The backlight panel 21 includes a light guide plate which is placed on a rear face of the display panel 11 and a plurality of LEDs serving as a light source. The plurality of LEDs are arranged in a matrix. The backlight panel 21 applies light generated at each of the plurality of LEDs to the image display region 12 of the display panel 11 through the light guide plate described above.

The LED driver 22 performs driving of the plurality of LEDs included in the backlight panel 21. The LED driver 22 is supplied with the data Data and the clock signal CLK from the scan output circuit 17 and generates an output current (LED drive current) which causes the LEDs included in the backlight panel 21 to emit light owing to this supply.

The control switch group 23 includes a plurality of control switches provided for sequentially switching LEDs to be driven in a time-division manner in matrix driving of the LEDs of the backlight panel 21.

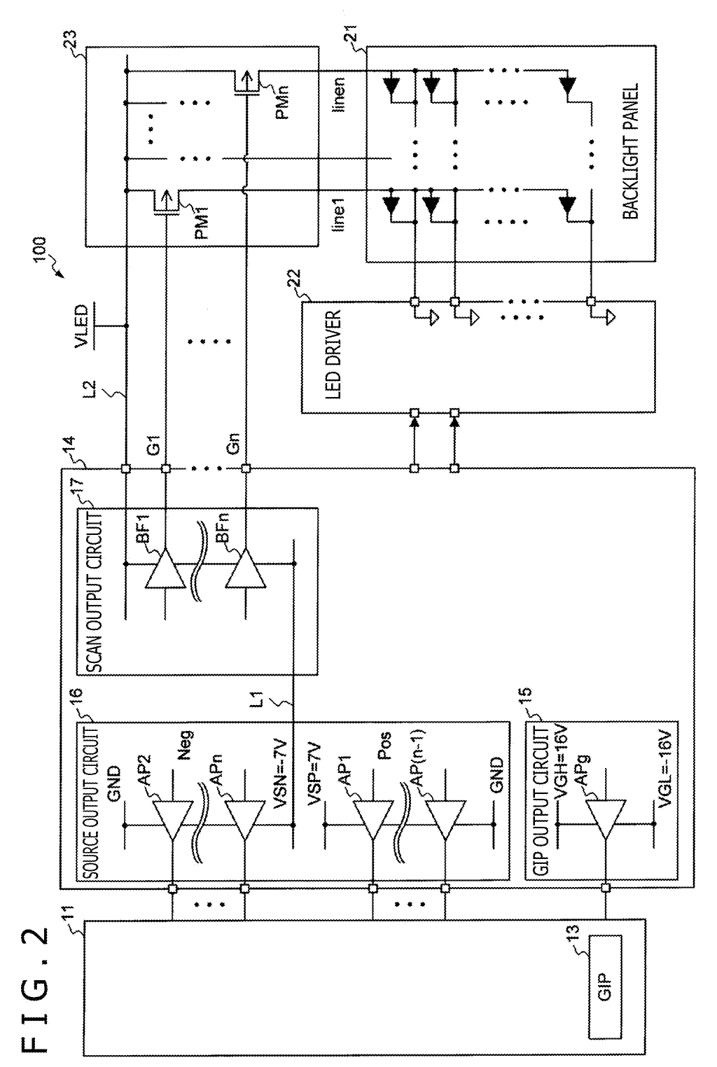

FIG. 2 is a circuit diagram illustrating configurations of the source output circuit 16, the scan output circuit 17, and its peripheral circuit blocks according to the present embodiment.

The GIP output circuit 15 has an amplifier APg which outputs a gate control signal Gout for controlling the GIP 13. The amplifier APg has a high-voltage-side power supply terminal connected to a voltage supply line of a voltage VGH (= 16V) that is a positive voltage and has a low-voltage-side power supply terminal connected to a voltage supply line of a voltage VGL (= -16V) that is a negative voltage, and performs an operation with the voltages VGH and VGL as power supplies.

The source output circuit 16 has amplifiers AP1 to APn which output the gray-scale voltage signals Vd1 to Vdn to the data lines DL1 to DLn. Among the amplifiers AP1 to APn, the amplifiers AP1, AP3, ..., AP(n-1) are positive-polarity output amplifiers. Also, the amplifiers AP2, AP4, ..., APn are negative-polarity output amplifiers. In the following description, the amplifiers AP1, AP3, ..., AP(n-1) are collectively referred to as positive-polarity output amplifier group AP1 to AP(n-1). In addition, the amplifiers AP2, AP4, ..., APn are collectively referred to as positive-polarity output amplifier group AP2 to APn.

Each amplifier of the positive-polarity output amplifier group AP1 to AP(n-1) has a high-voltage-side power supply terminal connected to a voltage supply line of a voltage VSP (= +7 V in the present embodiment) that is a positive voltage and has a low-voltage-side power supply terminal connected to a voltage supply line of a ground potential GND (= 0 V), and performs an operation with the voltage VSP and the ground potential GND as power supplies. Each amplifier of the negative-polarity output amplifier group AP2 to APn has a high-voltage-side power supply terminal connected to a voltage supply line of the ground potential GND and has a low-voltage-side power supply terminal connected to a voltage supply line L1 of a voltage VSN (= -7 V in the present embodiment) that is a negative voltage, and performs an operation with the ground potential GND and the voltage VSN as the power supplies.

The scan output circuit 17 has buffers BF1 to BFn which output gate signals G1 to Gn for matrix control. The gate signals G1 to Gn for matrix control are signals having a signal level changing to a high level (hereinafter, referred to as an H level) that is a logic level 1 and to a low level (hereinafter, referred to as an L level) that is a logic level 0. Each of the buffers BF1 to BFn has a high-voltage-side power supply terminal connected to a voltage supply line L2 of an LED power supply voltage VLED that is a positive power supply voltage and has a low-voltage-side power supply terminal connected to the voltage supply line L1 of the voltage VSN that is on the low voltage side, and performs an operation with the LED power supply voltage VLED and the voltage VSN as power supplies.

The control switch group 23 has control transistors PM1 to PMn as control switches. The control transistors PM1 to PMn are each constituted by an FET and are each constituted by a P-channel metal-oxide-semiconductor field-effect transistor (MOSFET), in the present embodiment. The control transistors PM1 to PMn have gates supplied with the gate signals G1 to Gn for matrix control such that the control transistors PM1 to PMn are controlled to be in on and off states, and each of the control transistors PM1 to PMn functions as control switches for sequentially switching the LEDs to be driven in a time-division manner.

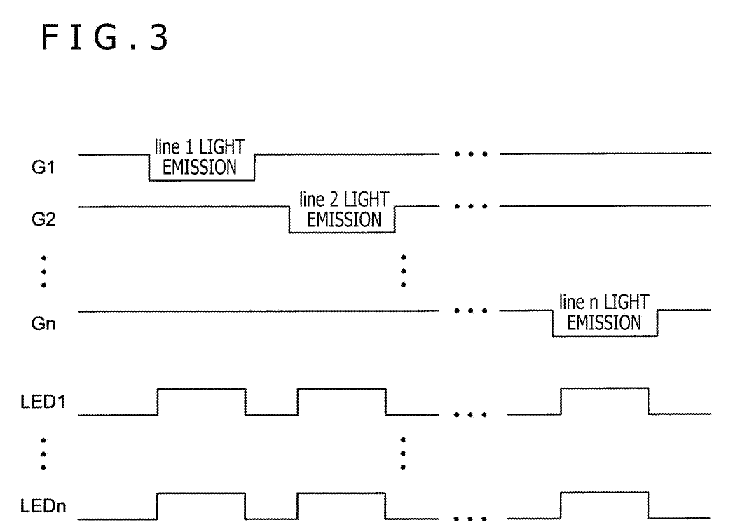

FIG. 3 is a timing chart indicating the gate signals G1 to Gn for matrix control and timings for light emission of the LEDs for each line in the present embodiment.

When the buffer BF1 of the scan output circuit 17 outputs the gate signal G1 for matrix control which is set to a low level for a predetermined period, the control transistor PM1 of the control switch group 23 which receives the relevant gate signal G1 at its gate is turned on. Owing to this, an LED current is supplied to the LEDs in the first column of the backlight panel 21, that is, in the column indicated with "line 1" in FIG. 2, and the LEDs emit light. Next, when the buffer BF2 outputs the gate signal G2 which is set to a low level for a predetermined period, the control transistor PM2 which receives the relevant gate signal G2 at its gate is turned on. Owing to this, an LED current is supplied to the LEDs in the second column of the backlight panel 21, that is, in the column indicated with "line 2" in FIG. 2, and the LEDs emit light. In the following, as in the operation described above, the gate signals are sequentially output until the gate signal Gn is output by the buffer BFn, and the LEDs up to the n-th column emit light.

In the scan output circuit 17 of the present embodiment, the low-voltage-side power supply terminal of each of the buffers BF1 to BFn of the scan output circuit 17 is connected to the voltage supply line L1 of the voltage VSN (= -7 V) that is a negative voltage. Accordingly, compared to a case in which the low-voltage-side power supply terminal is connected to the voltage supply line of the ground potential GND, it is possible to decrease the LED power supply voltage VLED.

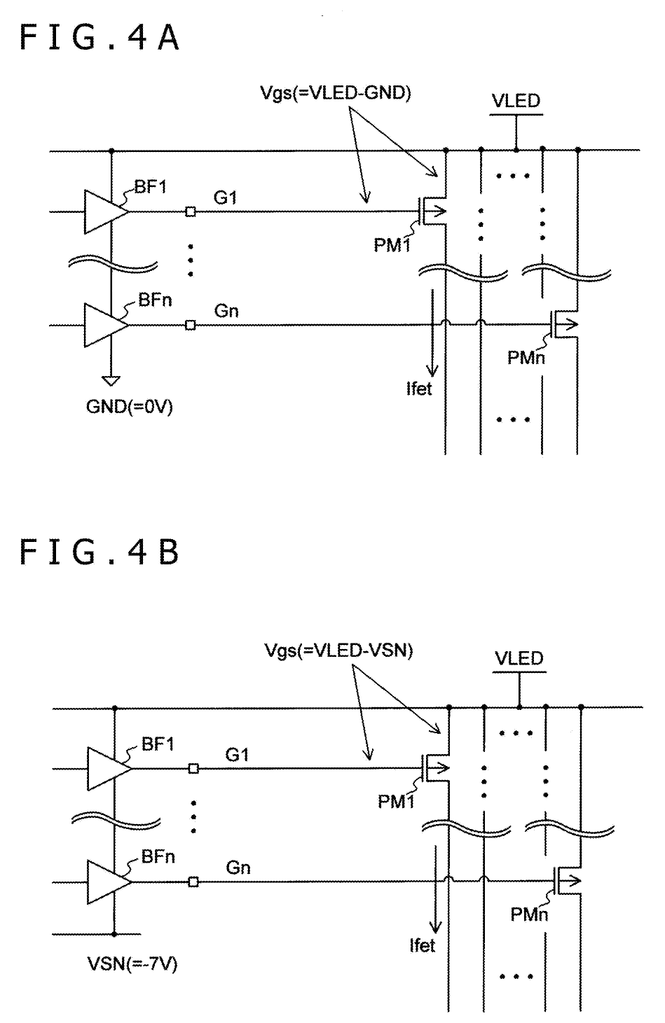

FIG. 4A is a diagram illustrating a gate-to-source voltage of a control transistor PM1 according to a comparative example in which the low-voltage-side power supply terminals of the buffers BF1 to BFn are connected to the voltage supply line of the ground potential GND, unlike the present embodiment. In the configuration of the comparative example, since the gate-to-source voltage Vgs of the control transistor PM1 is Vgs = (VLED - GND), in a case in which the gate-to-source voltage Vgs of 10 V is required, the voltage required as the LED power supply voltage VLED is VLED = (Vgs + GND) = (10V + 0V) = 10 V.

In contrast, FIG. 4B is a diagram illustrating a gate-to-source voltage of the control transistor PM1 according to the present embodiment. In the scan output circuit 17 of the present embodiment, the low-voltage-side power supply terminals of the buffers BF1 to BFn are connected to the voltage supply line L1 of the voltage VSN (= -7 V). Accordingly, since the gate-to-source voltage Vgs of the control transistor PM1 is Vgs = (VLED - VSN), in a case in which the gate-to-source voltage Vgs of 10 V is required, the voltage required as the LED power supply voltage is VLED = (Vgs + VSN) = (10V - 7V) = 3V.

Hence, with the scan output circuit 17 of the present embodiment, it is possible to make the LED power supply voltage VLED lower.

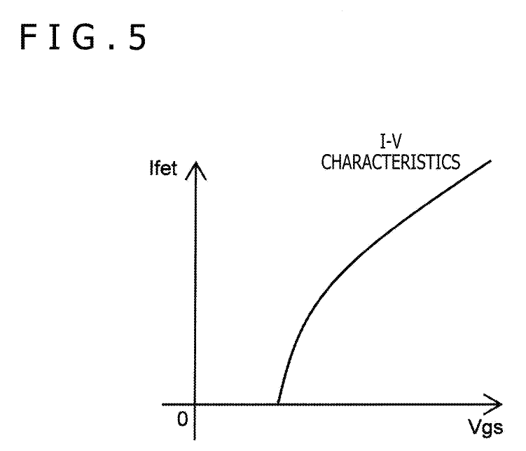

FIG. 5 is a graph indicating I-V characteristics of FETs (in the present embodiment, P channel MOSFETs) constituting the control transistors PM1 to PMn. In general, as the gate-to-source voltage Vgs becomes greater, a current Ifet flowing through the source and the drain of the FET becomes greater.

When the backlight panel 21 emits light, as the current Ifet flowing through each of the control transistors PM1 to PMn, a current amount corresponding to the current flowing through the LEDs of one column (corresponding to n channels) is required. According to the I-V characteristics of the FETs illustrated in FIG. 5, setting the LED power supply voltage VLED to high voltage also causes the voltage level of the gate-to-source voltage Vgs of each of the FETs to be higher, so that a larger amount of current can be made to flow. However, when the LED power supply voltage VLED is high, heat generation and power consumption resulting from losses in the control switch group 23 and the backlight panel 21 increase.

In contrast, according to the scan output circuit 17 of the present embodiment, since the LED power supply voltage VLED can be made lower as described above, it is possible to decrease the heat generation and the power consumption in the backlight panel 21.

In addition, the scan output circuit 17 of the present embodiment is provided in the TED 14 and uses, as the low-voltage-side power supply of the buffers BF1 to BFn, the voltage VSN (= -7 V) which is the negative voltage supplied as the low-voltage-side power supply voltage to the negative-polarity output amplifier group AP2 to APn of the source output circuit 16 that is provided in the TED 14 as well. Hence, compared to a case in which the scan output circuit 17 is provided outside the TED 14 as another IC, costs of the whole system can be decreased.

As described above, according to the scan output circuit 17 of the present embodiment, it is possible to flow a desired amount of current through the control transistor to be used for matrix driving for the LEDs of the backlight panel 21 and decrease the heat generation and the power consumption in the backlight panel 21.

### Second Embodiment

Next, a second embodiment of the present disclosure will be described.

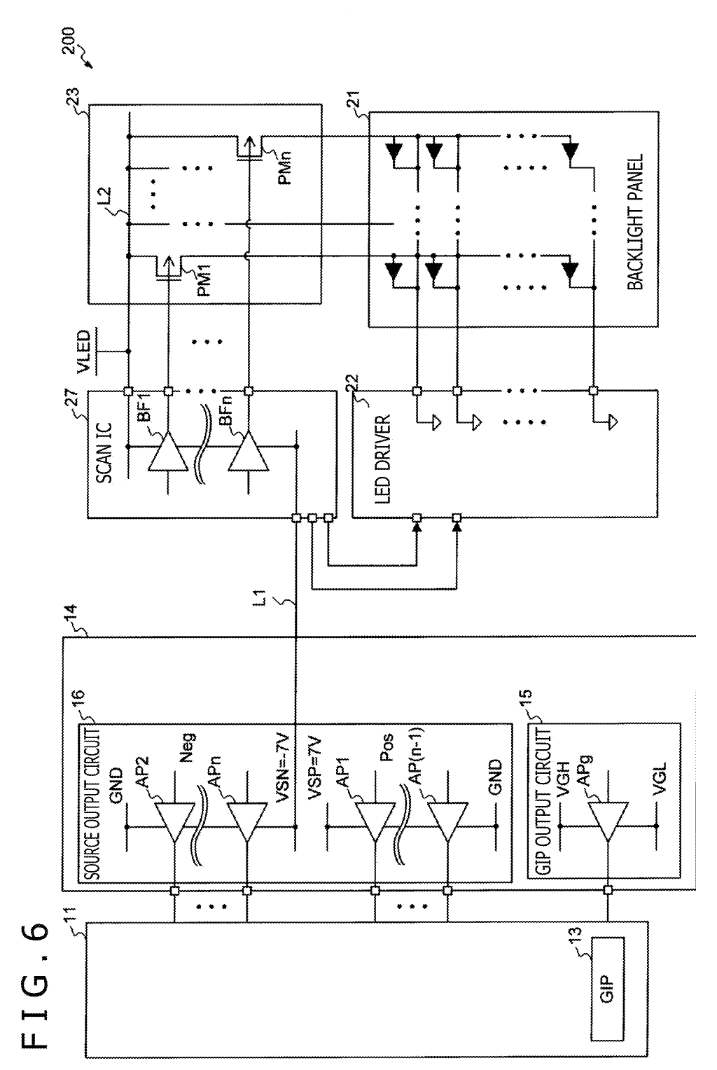

FIG. 6 is a circuit diagram illustrating a configuration of a liquid crystal display device 200 according to the second embodiment. The liquid crystal display device 200 of the present embodiment is different from the liquid crystal display device 100 of the first embodiment in that a scan IC 27 is provided not inside a TED 14 but outside the TED 14.

The scan IC 27 has buffers BF1 to BFn which output gate signals G1 to Gn for matrix control. The buffers BF1 to BFn each have a high-voltage-side power supply terminal connected to the voltage supply line L2 of an LED power supply voltage VLED and each have a low-voltage-side power supply terminal connected to a voltage supply line L1 of a voltage VSN, and performs an operation with the LED power supply voltage VLED and the voltage VSN as power supplies.

In the scan IC 27 of the present embodiment, as in the scan output circuit 17 of the first embodiment, the low-voltage-side power supply terminals of the buffers BF1 to BFn are connected to the voltage supply line L1 of the voltage VSN (= -7 V) that is a negative voltage. Accordingly, compared to a case in which the low-voltage-side power supply terminal is connected to the voltage supply line of the ground potential GND, it is possible to make the LED power supply voltage VLED lower.

Hence, according to the scan IC 27 of the present embodiment, while a desired amount of current is caused to flow through the control transistor to be used for matrix driving for the LEDs of the backlight panel 21, it is possible to decrease the heat generation and the power consumption in the backlight panel 21.

In addition, since the scan IC 27 may be provided as another IC outside the TED 14, it is possible to achieve a device configuration using the existing TED.

Note that the present disclosure is not limited to those indicated in the embodiments described above. For example, in the embodiments described above, a case in which such relations as VSP = 7V and VSN = -7 V are satisfied has been described as an example, but a voltage value of each voltage is not limited to this, and it is sufficient if the voltage VSP has a positive polarity and the voltage VSN has a negative polarity.

In addition, in the embodiments described above, there has been described, as an example, a case in which the voltage VSN that is a negative voltage to be supplied to the negative-polarity output amplifier group AP2 to APn of the source output circuit 16 as the low-voltage-side power supply voltage is used as the low-voltage-side power supply of the buffers BF1 to BFn. However, as an alternative configuration, other negative voltages than the voltage VSN included in the TED 14 may be used as the low-voltage-side power supply of the buffers BF1 to BFn. For example, a voltage VCL (for example, -3 V) to be used for a level shifter (L/S), the voltage VGL (for example, -16 V) to be used for the GIP output circuit 15, and other voltages may be used as the low-voltage-side power supply of the buffers BF1 to BFn.

### Notes

The present specification discloses the following configurations.

### Configuration 1

A scan output circuit which is connected to a plurality of field-effect transistors each supplying a drain-source current to a backlight panel including a plurality of light-emitting diodes arranged in a matrix and which supplies a gate voltage to each of the plurality of field-effect transistors, including:
a plurality of voltage output sections which are provided corresponding to the plurality of field-effect transistors and each of which outputs the gate voltage,
in which each of the plurality of voltage output sections is supplied with a positive power supply voltage through a first voltage supply line connected in common to a source of each of the plurality of field-effect transistors and is supplied with a negative voltage through a second voltage supply line, and according to the positive power supply voltage and the negative voltage, outputs a voltage which varies in voltage level between a high level and a low level and which has a negative voltage value at the low level, as the gate voltage.

### Configuration 2

The scan output circuit according to Configuration 1,

in which the scan output circuit is connected to a source driver having a positive-polarity output amplifier group which outputs a positive-polarity gray-scale voltage signal and a negative-polarity output amplifier group which outputs a negative-polarity gray-scale voltage signal, and

the second voltage supply line is a voltage supply line for supplying a negative power supply voltage to the negative-polarity output amplifier group.

### Configuration 3

The scan output circuit according to Configuration 1 or 2,

in which the plurality of field-effect transistors are provided corresponding to each column of the plurality of light-emitting diodes arranged in a matrix, and

each of the plurality of voltage output sections sequentially supplies the gate voltage to each of the plurality of field-effect transistors in such a manner that the plurality of light-emitting diodes sequentially emit light for each column.

### Configuration 4

The scan output circuit according to Configuration 2,

in which the scan output circuit is provided in a same integrated circuit as the source driver.

### Configuration 5

The scan output circuit according to Configuration 2, in which the scan output circuit is provided in an integrated circuit different from the source driver.

### Configuration 6

A display device including:
a liquid crystal display panel including a plurality of data lines, a plurality of gate lines, and a plurality of pixel sections provided at each intersection of the plurality of data lines and the plurality of gate lines in a matrix;
a source driver which receives a video data signal including a series of a plurality of pieces of pixel data and representing a video image to be displayed on the liquid display panel and supplies gray-scale voltage signals to the plurality of pixel sections through the plurality of data lines according to the video data signal;
a backlight panel placed on a rear face of the liquid crystal display panel and having a plurality of light-emitting diodes arranged in a matrix;
a light-emitting diode driver which drives the plurality of light-emitting diodes;
a control switch group including a plurality of field-effect transistors each of which supplies a drain-source voltage thereof to the plurality of light-emitting diodes for each column; and
a scan output circuit including a plurality of voltage output sections which are provided corresponding to the plurality of field-effect transistors and each of which outputs a gate voltage and supplying the gate voltage to each of the plurality of field-effect transistors of the control switch group,
in which each of the plurality of voltage output sections of the scan output circuit is supplied with a positive power supply voltage through a first voltage supply line connected in common to a source of each of the plurality of field-effect transistors and is supplied with a negative voltage through a second voltage supply line connected in common to a negative-polarity output amplifier group of the source driver, and according to the positive power supply voltage and the negative voltage, outputs a voltage which varies in voltage level between a high level and a low level and which has a negative voltage value at the low level, as the gate voltage.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2025-072314 filed in the Japan Patent Office on April 24, 2025, the entire content of which is hereby incorporated by reference.

What is claimed is:

1. A scan output circuit which is connected to a plurality of field-effect transistors each supplying a drain-source current to a backlight panel including a plurality of light-emitting diodes arranged in a matrix and which supplies a gate voltage to each of the plurality of field-effect transistors, comprising:
a plurality of voltage output sections which are provided corresponding to the plurality of field-effect transistors and each of which outputs the gate voltage,
wherein each of the plurality of voltage output sections is supplied with a positive power supply voltage through a first voltage supply line connected in common to a source of each of the plurality of field-effect transistors and is supplied with a negative voltage through a second voltage supply line, and according to the positive power supply voltage and the negative voltage, outputs a voltage which varies in voltage level between a high level and a low level and which has a negative voltage value at the low level, as the gate voltage.

2. The scan output circuit according to claim 1,
wherein the scan output circuit is connected to a source driver having a positive-polarity output amplifier group which outputs a positive-polarity gray-scale voltage signal and a negative-polarity output amplifier group which outputs a negative-polarity gray-scale voltage signal, and
the second voltage supply line is a voltage supply line for supplying a negative power supply voltage to the negative-polarity output amplifier group.

3. The scan output circuit according to claim 1,
wherein the plurality of field-effect transistors are provided corresponding to each column of the plurality of light-emitting diodes arranged in a matrix, and
each of the plurality of voltage output sections sequentially supplies the gate voltage to each of the plurality of field-effect transistors in such a manner that the plurality of light-emitting diodes sequentially emit light for each column.

4. The scan output circuit according to claim 2,
wherein the scan output circuit is provided in a same integrated circuit as the source driver.

5. The scan output circuit according to claim 2,
wherein the scan output circuit is provided in an integrated circuit different from the source driver.

6. A display device comprising:
a liquid crystal display panel including a plurality of data lines, a plurality of gate lines, and a plurality of pixel sections provided at each intersection of the plurality of data lines and the plurality of gate lines in a matrix;
a source driver which receives a video data signal including a series of a plurality of pieces of pixel data and representing a video image to be displayed on the liquid display panel and supplies gray-scale voltage signals to the plurality of pixel sections through the plurality of data lines according to the video data signal;
a backlight panel placed on a rear face of the liquid crystal display panel and having a plurality of light-emitting diodes arranged in a matrix;
a light-emitting diode driver which drives the plurality of light-emitting diodes;
a control switch group including a plurality of field-effect transistors each of which supplies a drain-source voltage thereof to the plurality of light-emitting diodes for each column; and
a scan output circuit including a plurality of voltage output sections which are provided corresponding to the plurality of field-effect transistors and each of which outputs a gate voltage and supplying the gate voltage to each of the plurality of field-effect transistors of the control switch group,
wherein each of the plurality of voltage output sections of the scan output circuit is supplied with a positive power supply voltage through a first voltage supply line connected in common to a source of each of the plurality of field-effect transistors and is supplied with a negative voltage through a second voltage supply line connected in common to a negative-polarity output amplifier group of the source driver, and according to the positive power supply voltage and the negative voltage, outputs a voltage which varies in voltage level between a high level and a low level and which has a negative voltage value at the low level, as the gate voltage.
